(19) United States
(12) Patent Application Publication
(10) Pub. No.: US 2025/0317886 A1
(43) Pub. Date: Oct. 9, 2025

(54) LOCATION MANAGEMENT FUNCTION NETWORK ELEMENT SELECTION METHOD AND DEVICE

(71) Applicant: Beijing Xiaomi Mobile Software Co., Ltd., Beijing (CN)

(72) Inventors: Yang SHEN, Beijing (CN); Xinli WANG, Beijing (CN)

(73) Assignee: Beijing Xiaomi Mobile Software Co., Ltd., Beijing (CN)

(21) Appl. No.: 18/863,136

(22) PCT Filed: May 6, 2022
(86) PCT No.: PCT/CN2022/091320

§ 371 Date: Nov. 5, 2024

(51) Int. Cl. H04W 64/00; G01S 5/02; H04W 92/18

(52) U.S. Cl. CPC H04W 64/00; G01S 5/0289; H04W 92/18

(57) ABSTRACT

An LMF network element selection method includes selecting, based on a ranging/sidelink positioning request as received, an LMF network element configured to perform a ranging/sidelink positioning service.

### CROSS-REFERENCE TO RELATED APPLICATIONS

The present application is a U.S. National Stage of International Application No. PCT/CN2022/091320, filed on May 6, 2022, the entire content of which is incorporated herein by reference for all purposes.

### TECHNICAL FIELD

The present disclosure relates to the field of mobile communication technologies, and in particular relates to a location management function (LMF) network element selection method and device.

### BACKGROUND

In a wireless communication system, position information of a user equipment (UE) is typically determined by an LMF network element, which facilitates achievement of communications between two or more UEs. The position information of the UE may be determined through a ranging/sidelink positioning service, where ranging is used for determining a distance and/or a direction and/or a relative position between two or more UEs, and sidelink positioning is used for positioning the UE.

### SUMMARY

The present disclosure proposes an LMF network element selection method and device.

The embodiments in a first aspect of the present disclosure provide an LMF network element selection method, performed by an AMF network element, where the method includes selecting, based on a ranging/sidelink positioning request as received, an LMF network element configured to perform a ranging/sidelink positioning service.

The embodiments in a second aspect of the present disclosure provide a communication device including a transceiver, a memory and a processor that is connected to the transceiver and the memory respectively, where the processor, through executing a computer-executable instruction of the memory, is configured to control receiving and sending of a wireless signal of the transceiver, and is capable of implementing the LMF network element selection method of the embodiments in the first aspect described above.

The embodiments in a third aspect of the present disclosure provide a computer storage medium, where the computer storage medium stores a computer-executable instruction; and the computer-executable instruction, when executed by a processor, is capable of implementing the LMF network element selection method of the embodiments in the first aspect described above.

Additional aspects and advantages of the present disclosure will be partially presented in the following description, and will partially become apparent from the following description, or be learned through practice of the present disclosure.

### BRIEF DESCRIPTION OF THE DRAWINGS

The foregoing and/or additional aspects and advantages of the present disclosure will become apparent and readily understood from the following description of the embodiments in conjunction with the accompanying drawings, where:

FIG. 1 is a schematic diagram illustrating a direction of one terminal relative to another terminal;

FIG. 2 is a schematic diagram illustrating provision of a ranging service by a UE within or outside a 5G coverage;

FIG. 3 is a schematic flow diagram of an LMF network element selection method according to an embodiment of the present disclosure;

FIG. 4 is a schematic flow diagram of an LMF network element selection method according to an embodiment of the present disclosure;

FIG. 5 is a schematic flow diagram of an LMF network element selection method according to an embodiment of the present disclosure;

FIG. 6 is a schematic flow diagram of an LMF network element selection method according to an embodiment of the present disclosure;

FIG. 7 is a schematic flow diagram of an LMF network element selection method according to an embodiment of the present disclosure;

FIG. 8 is a schematic flow diagram of an LMF network element selection method according to an embodiment of the present disclosure;

FIG. 9 is a schematic flow diagram of an LMF network element selection method according to an embodiment of the present disclosure;

FIG. 10 is a schematic flow diagram of a ranging/sidelink positioning service according to an embodiment of the present disclosure;

FIG. 11 is a block diagram of an LMF network element selection device according to an embodiment of the present disclosure;

FIG. 12 is a schematic structural diagram of a communication device provided by an embodiment of the present disclosure; and

FIG. 13 is a schematic structural diagram of a chip provided by an embodiment of the present disclosure.

### DETAILED DESCRIPTION

Embodiments of the present disclosure are described in detail below, and examples of the embodiments are shown in the accompanying drawings, where the same or similar numerals throughout indicate the same or similar elements or elements having the same or similar function. The embodiments described below with reference to the accompanying drawings are exemplary and are intended for use in explaining the present disclosure, and are not to be construed as limiting the present disclosure.

In a wireless communication system, position information of a UE is typically determined by an LMF network element, which facilitates achievement of communications between two or more UEs. The position information of the UE may be determined through a ranging/sidelink positioning service, where ranging is used for determining a distance and/or a direction and/or a relative position between two or more UEs, and sidelink positioning is used for positioning the UE. However, since not all LMF network elements are capable of supporting the ranging/sidelink positioning service, how to select a suitable LMF network element for performing the ranging/sidelink positioning service has become an urgent problem to be solved currently.

Ranging/sidelink positioning includes one or both of distance measurement and direction measurement.

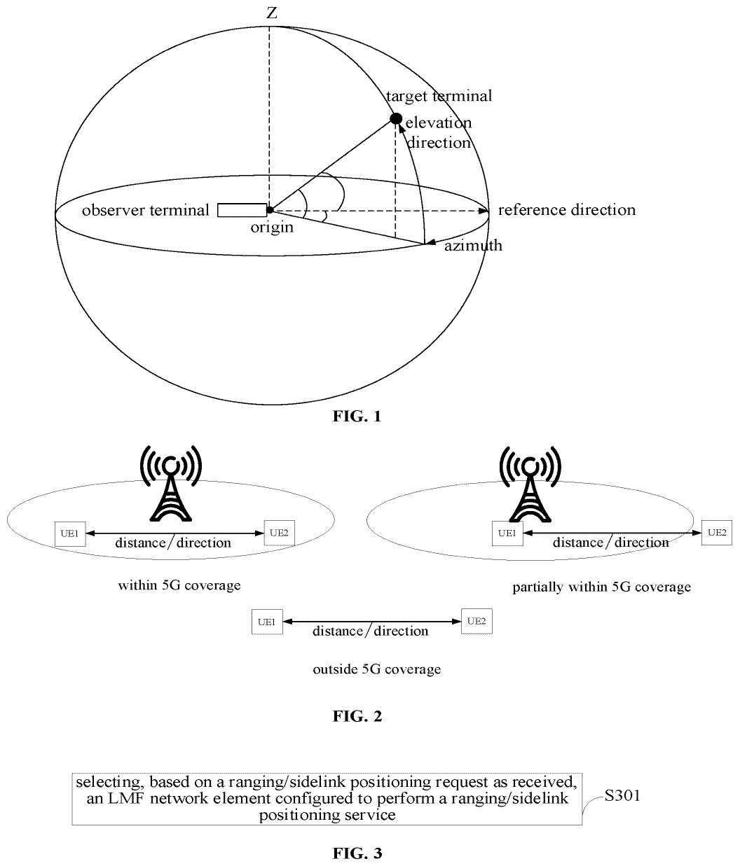

In the three-dimensional cases, the direction of one terminal relative to another terminal includes a horizontal direction and an elevation direction, as shown in FIG. 1. The observer terminal is provided with a reference plane and a reference direction. The direction of the target terminal relative to the observer terminal is the angle between the connection line from the observer terminal to the target terminal and the reference direction, and may be represented by the azimuth angle and the elevation direction. The azimuth angle is indicated by the angle between the reference direction and the projection, on the reference plane, of the connection line from the observer terminal to the target terminal, where the reference direction is orthogonal to the z axis. The elevation direction of the target terminal is the angle above the horizontal plane.

Ranging/sidelink positioning services can be supported within or outside a SG coverage, as shown in FIG. 2. If the licensed frequency band can be used for ranging, the licensed frequency band should be under full control of the operator.

In some ranging/sidelink positioning scenarios, the LMF network element is configured to initiate a ranging/sidelink positioning process to the UE. The LMF network element is configured to determine the position of the UE. However, not every LMF network element is capable of processing a ranging/sidelink positioning request, i.e., initiating a ranging/sidelink positioning process to the UE based on a request received from the AMF network element, and generating a ranging/sidelink positioning result based on the measurement data and reporting the result to the AMF network element. If an LMF network element is required to participate in the ranging/sidelink positioning process, the AMF network element needs to select an LMF network element that supports the ranging/sidelink positioning function. As a result, how to select a suitable LMF network element for performing the ranging/sidelink positioning service has become an urgent problem to be solved currently.

To this end, the present disclosure proposes an LMF network element selection method and device, enabling an AMF network element to select a suitable LMF network element for performing the ranging/sidelink positioning service.

The LMF network element selection method and device provided in the present application are described in detail below in conjunction with the accompanying drawings.

FIG. 3 illustrates a schematic flow diagram of an LMF network element selection method according to an embodiment of the present disclosure. As shown in FIG. 3, the method may be performed by an AMF network element, and may include the following step S301.

At S301, an LMF network element configured to perform a ranging/sidelink positioning service is selected based on a ranging/sidelink positioning request as received.

In a scenario of performing the ranging/sidelink positioning service, when the AMF network element receives a ranging/sidelink positioning request and determines to use an LMF network element to perform the ranging/sidelink positioning service, the LMF network element selection is performed.

According to the LMF network element selection method of the embodiment of the present disclosure, the AMF network element selects, based on the ranging/sidelink positioning request as received, the LMF network element configured to perform the ranging/sidelink positioning service. As a result, the AMF network element is enabled to select a suitable LMF network element for performing the ranging/sidelink positioning service.

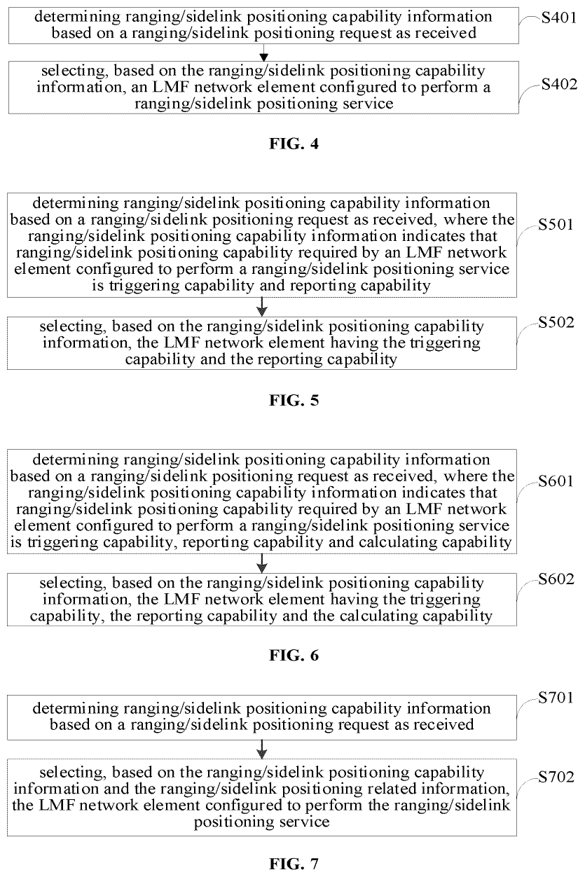

FIG. 4 illustrates a schematic flow diagram of an LMF network element selection method according to an embodiment of the present disclosure. As shown in FIG. 4, the method may be performed by an AMF network element, and may include the following steps S401 to S402.

At S401, ranging/sidelink positioning capability information is determined based on a ranging/sidelink positioning request as received.

The ranging/sidelink positioning capability information indicates ranging/sidelink positioning capability required by an LMF network element configured to perform a ranging/sidelink positioning service.

At S402, the LMF network element configured to perform the ranging/sidelink positioning service is selected based on the ranging/sidelink positioning capability information.

In a scenario of performing the ranging/sidelink positioning service, when the AMF network element receives a ranging/sidelink positioning request and determines to use an LMF network element to perform the ranging/sidelink positioning service, the LMF network element selection is performed. In order to support the ranging/sidelink positioning service, the selected LMF network element needs to have the ranging/sidelink positioning capability required for performing the ranging/sidelink positioning service.

The AMF network element, when performing the LMF network element selection, may determine the ranging/sidelink positioning capability information that indicates the ranging/sidelink positioning capability required by the LMF network element configured to perform the ranging/sidelink positioning service, and select the LMF network element based on the ranging/sidelink positioning capability information. As a result, the AMF network element is enabled to select an LMF network element having suitable ranging/sidelink positioning capability for performing the ranging/sidelink positioning service.

In some embodiments, the ranging/sidelink positioning capability includes triggering capability that is used for triggering, based on the request received from the AMF network element, a ranging/sidelink positioning service between two or more UEs, and reporting capability that is used for reporting a ranging/sidelink positioning result to the AMF network element.

In order to support the ranging/sidelink positioning service, the selected LMF network element at least needs to have the triggering capability and the reporting capability, where the triggering capability is used for triggering, based on the request received from the AMF network element, a ranging/sidelink positioning service between two or more UEs, and the reporting capability is used for reporting a ranging/sidelink positioning result to the AMF network element.

In some embodiments, the ranging/sidelink positioning capability further includes calculating capability used for calculating the ranging/sidelink positioning result.

In order to support the ranging/sidelink positioning service, in addition to the triggering capability and the reporting capability, the selected LMF network element needs to have the calculating capability, where the calculating capability is used for calculating the ranging/sidelink positioning result based on the ranging/sidelink positioning measurement data.

It should be noted that when the selected LMF network element does not have the calculating capability used for calculating the ranging/sidelink positioning result, the UE is required to calculate the ranging/sidelink positioning result and send the calculated ranging/sidelink positioning result to the LMF network element.

In an example, if the AMF network element determines, in response to the ranging/sidelink positioning request as received, the ranging/sidelink positioning capability information indicative of the triggering capability and the reporting capability, the AMF network element may select an LMF network element having the triggering capability and the reporting capability.

In another example, if the AMF network element determines, in response to the ranging/sidelink positioning request as received, the ranging/sidelink positioning capability information indicative of the triggering capability, the reporting capability and the calculating capability, the AMF network element may select an LMF network element having the triggering capability, the reporting capability and the calculating capability.

In some embodiments, the calculating capability includes any one of the following: calculation of a relative distance between two UEs; calculation of a relative direction between two UEs; calculation of a relative distance with a specified accuracy between two UEs; calculation of a relative direction with a specified accuracy between two UEs; calculation of a relative distance between a UE and a plurality of UEs; calculation of a relative direction between a UE and a plurality of UEs; calculation of a relative distance with a specified accuracy between a UE and a plurality of UEs; and calculation of a relative direction with a specified accuracy between a UE and a plurality of UEs.

The calculating capability possessed by the selected LMF network element may include calculation of a relative distance and/or a relative direction between a UE and one or more UEs, and in particular, a relative distance and/or a relative direction with a specified accuracy between a UE and one or more UEs may be calculated.

In the cases of the unspecified accuracy, the LMF network element may calculate, based on a default accuracy or an actual measurement condition, a relative distance and/or a relative direction between a UE and one or more UEs.

According to the LMF network element selection method of the embodiments of the present disclosure, the AMF network element determines, based on the ranging/sidelink positioning request as received, the ranging/sidelink positioning capability information required for performing the ranging/sidelink positioning service, and selects, based on the ranging/sidelink positioning capability information, the LMF network element configured to perform the ranging/sidelink positioning service. As a result, the AMP network element is enabled to select a suitable LMF network element for performing the ranging/sidelink positioning service.

FIG. 5 illustrates a schematic flow diagram of an LMF network element selection method according to an embodiment of the present disclosure. As shown in FIG. 5, the method may be performed by an AMF network element, and may include the following steps S501 to S502.

At S501, ranging/sidelink positioning capability information is determined based on a ranging/sidelink positioning request as received, where the ranging/sidelink positioning capability information indicates that ranging/sidelink positioning capability required by an LMF network element configured to perform a ranging/sidelink positioning service is triggering capability and reporting capability.

At S502, the LMF network element having the triggering capability and the reporting capability is selected based on the ranging/sidelink positioning capability information.

In order to support the ranging/sidelink positioning service, the selected LMF network element at least needs to have the triggering capability and the reporting capability, where the triggering capability is used for triggering, based on the request received from the AMF network element, a ranging/sidelink positioning service between two or more UEs, and the reporting capability is used for reporting a ranging/sidelink positioning result to the AMF network element.

If the AMF network element determines, in response to the ranging/sidelink positioning request as received, the ranging/sidelink positioning capability information indicative of the triggering capability and the reporting capability, the AMF network element may select an LMF network element having the triggering capability and the reporting capability.

According to the LMF network element selection method of the embodiments of the present disclosure, the AMF network element determines, based on the ranging/sidelink positioning request as received, that the ranging/sidelink positioning capability required for performing the ranging/sidelink positioning service is the triggering capability and the reporting capability, then the AMF network element may select the LMF network element having the triggering capability and the reporting capability. As a result, the AMF network element is enabled to select a suitable LMF network element for performing the ranging/sidelink positioning service.

FIG. 6 illustrates a schematic flow diagram of an LMF network element selection method according to an embodiment of the present disclosure. As shown in FIG. 6, the method may be performed by an AMF network element, and may include the following steps S601 to S602.

At S601, ranging/sidelink positioning capability information is determined based on a ranging/sidelink positioning request as received, where the ranging/sidelink positioning capability information indicates that ranging/sidelink positioning capability required by an LMF network element configured to perform a ranging/sidelink positioning service is triggering capability, reporting capability and calculating capability.

At S602, the LMF network element having the triggering capability, the reporting capability and the calculating capability is selected based on the ranging/sidelink positioning capability information.

In order to support the ranging/sidelink positioning service, the selected LMF network element at least needs to have the triggering capability and the reporting capability, where the triggering capability is used for triggering, based on the request received from the AMF network element, a ranging/sidelink positioning service between two or more UEs, and the reporting capability is used for reporting a ranging/sidelink positioning result to the AMF network element. In addition to the triggering capability and the reporting capability, the selected LMF network element may have the calculating capability, where the calculating capability is used for calculating the ranging/sidelink positioning result based on the ranging/sidelink positioning measurement data.

If the AMF network element determines, in response to the ranging/sidelink positioning request as received, the ranging/sidelink positioning capability information indicative of the triggering capability, the reporting capability and the calculating capability, the AMF network element may select an LMF network element having the triggering capability, the reporting capability and the calculating capability.

In some embodiments, the calculating capability includes any one of the following: calculation of a relative distance between two UEs; calculation of a relative direction between two UEs; calculation of a relative distance with a specified accuracy between two UEs; calculation of a relative direction with a specified accuracy between two UEs; calculation of a relative distance between a UE and a plurality of UEs; calculation of a relative direction between a UE and a plurality of UEs; calculation of a relative distance with a specified accuracy between a UE and a plurality of UEs; and calculation of a relative direction with a specified accuracy between a UE and a plurality of UEs.

The calculating capability possessed by the selected LMF network element may include calculation of a relative distance and/or a relative direction between a UE and one or more UEs, and in particular, a relative distance and/or a relative direction with a specified accuracy between a UE and one or more UEs may be calculated.

In the cases of the unspecified accuracy, the LMF network element may calculate, based on a default accuracy or an actual measurement condition, a relative distance and/or a relative direction between a UE and one or more UEs.

According to the LMF network element selection method of the embodiments of the present disclosure, the AMF network element determines, based on the ranging/sidelink positioning request as received, that the ranging/sidelink positioning capability required for performing the ranging/sidelink positioning service is the triggering capability, the reporting capability and the calculating capability, then the AMF network element may select the LMF network element having the triggering capability, the reporting capability and the calculating capability. As a result, the AMF network element is enabled to select a suitable LMF network element for performing the ranging/sidelink positioning service.

FIG. 7 illustrates a schematic flow diagram of an LMF network element selection method according to an embodiment of the present disclosure. As shown in FIG. 7, the method may be performed by an AMF network element, and may include the following steps S701 to S702.

At S701, ranging/sidelink positioning capability information is determined based on a ranging/sidelink positioning request as received.

The ranging/sidelink positioning capability information indicates ranging/sidelink positioning capability required by an LMF network element configured to perform a ranging/sidelink positioning service. The ranging/sidelink positioning request includes ranging/sidelink positioning related information.

At S702, the LMF network element configured to perform the ranging/sidelink positioning service is selected based on the ranging/sidelink positioning capability information and the ranging/sidelink positioning related information.

The ranging/sidelink positioning related information includes at least one of the following: ranging/sidelink positioning content that is used for indicating a desired ranging/sidelink positioning result; and ranging/sidelink positioning quality of service (QoS) information.

In a scenario of performing the ranging/sidelink positioning service, when the AMF network element receives a ranging/sidelink positioning request and determines to use an LMF network element to perform the ranging/sidelink positioning service, the LMF network element selection is performed. In order to support the ranging/sidelink positioning service, the selected LMF network element needs to have the ranging/sidelink positioning capability required for performing the ranging/sidelink positioning service.

The ranging/sidelink positioning request received by the AMF network element includes the ranging/sidelink positioning related information. The AMF network element, when performing the LMF network element selection, may determine the ranging/sidelink positioning capability information that indicates the ranging/sidelink positioning capability required by the LMF network element configured to perform the ranging/sidelink positioning service, and select the LMF network element based on the ranging/sidelink positioning capability information and the ranging/sidelink positioning related information. As a result, the AMF network element is enabled to select an LMF network element having suitable ranging/sidelink positioning capability for performing the ranging/sidelink positioning service.

Specifically, the ranging/sidelink positioning related information may include the ranging/sidelink positioning content and/or the ranging/sidelink positioning QoS information.

In some embodiments, the ranging/sidelink positioning content is used for indicating a desired ranging/sidelink positioning result, for example, the ranging/sidelink positioning content indicates that the desired ranging/sidelink positioning result is a distance and/or a direction. When the desired ranging/sidelink positioning result is a distance, the LMF network element selected by the AMF network element should be capable of obtaining the distance as the ranging/sidelink positioning result. When the desired ranging/sidelink positioning result is a direction, the LMF network element selected by the AMF network element should be capable of obtaining the direction as the ranging/sidelink positioning result.

In some embodiments, the ranging/sidelink positioning QoS information includes a QoS level, a specified accuracy related to the desired ranging/sidelink positioning result, and a response time for performing the ranging/sidelink positioning service.

In some embodiments, the QoS level includes a best effort level, a multi-QoS level, and a guaranteed level.

The best effort level defines the least stringent requirement for the QoS. For example, if a position estimate as obtained does not satisfy the QoS requirement, the position estimate may still be returned but should include indication information indicating that the requested QoS is not satisfied; if a position estimate is not obtained, an error indication should be sent.

The multi-QoS level defines the moderately stringent requirement for the QoS. For example, if a position estimate as obtained does not satisfy the most stringent QoS requirement, an additional position estimate may be triggered at the LMF network element to attempt to satisfy another QoS requirement that is less stringent, and the process may be iterated until the least stringent another QoS requirement has been attempted, and if the position estimate as obtained does not satisfy that least stringent another QoS requirement, the position estimation should be abandoned, and an error indication is sent.

The guaranteed level defines the most stringent requirement for the QoS. For example, if the position estimate as obtained does not satisfy the QoS requirement, the position estimation should be abandoned, and an error indication is sent.

In some embodiments, when the desired ranging/sidelink positioning result is a distance, the specified accuracy related to the desired ranging/sidelink positioning result may indicate the specified accuracy relative to the distance. When the desired ranging/sidelink positioning result is a direction, the specified accuracy related to the desired ranging/sidelink positioning result may indicate the specified accuracy relative to the direction.

The response time for performing the ranging/sidelink positioning service may indicate that the response time is a specified length of time.

In some embodiments, the ranging/sidelink positioning capability includes triggering capability that is used for triggering a ranging/sidelink positioning service between two or more UEs, and reporting capability that is used for reporting a ranging/sidelink positioning result to the AMF network element.

In order to support the ranging/sidelink positioning service, the selected LMF network element at least needs to have the triggering capability and the reporting capability, where the triggering capability is used for triggering, based on the request received from the AMF network element, a ranging/sidelink positioning service between two or more UEs, and the reporting capability is used for reporting a ranging/sidelink positioning result to the AMF network element.

In some embodiments, the ranging/sidelink positioning capability further includes calculating capability used for calculating the ranging/sidelink positioning result.

In order to support the ranging/sidelink positioning service, in addition to the triggering capability and the reporting capability, the selected LMF network element needs to have the calculating capability, where the calculating capability is used for calculating the ranging/sidelink positioning result based on the ranging/sidelink positioning measurement data.

It should be noted that when the selected LMF network element does not have the calculating capability used for calculating the ranging/sidelink positioning result, the UE is required to calculate the ranging/sidelink positioning result and send the calculated ranging/sidelink positioning result to the LMF network element.

In an example, if the AMF network element receives a ranging/sidelink positioning request including the ranging/sidelink positioning content, the AMF network element determines, in response to the ranging/sidelink positioning request, the ranging/sidelink positioning capability information indicative of the triggering capability and the reporting capability, and the ranging/sidelink positioning content indicates that the desired ranging/sidelink positioning result is a distance, then the AMF network element may select, based on the ranging/sidelink positioning capability information and the ranging/sidelink positioning content, an LMF network element having the triggering capability and the reporting capability, and capable of obtaining the distance as the ranging/sidelink positioning result.

In another example, if the AMF network element receives a ranging/sidelink positioning request including the ranging/sidelink positioning QoS information, the AMF network element determines, in response to the ranging/sidelink positioning request as received, the ranging/sidelink positioning capability information indicative of the triggering capability, the reporting capability and the calculating capability, and the ranging/sidelink positioning QoS information indicates that the response time for performing the ranging/sidelink positioning service is a low latency, then the AMF network element may select, based on the ranging/sidelink positioning capability information and the ranging/sidelink positioning QoS information, an LMF network element having the triggering capability, the reporting capability, the calculating capability, and the low latency.

In some embodiments, the calculating capability includes any one of the following: calculation of a relative distance between two UEs; calculation of a relative direction between two UEs; calculation of a relative distance with a specified accuracy between two UEs; calculation of a relative direction with a specified accuracy between two UEs; calculation of a relative distance between a UE and a plurality of UEs; calculation of a relative direction between a UE and a plurality of UEs; calculation of a relative distance with a specified accuracy between a UE and a plurality of UEs; and calculation of a relative direction with a specified accuracy between a UE and a plurality of UEs.

The calculating capability possessed by the selected LMF network element may include calculation of a relative distance and/or a relative direction between a UE and one or more UEs, and in particular, a relative distance and/or a relative direction with a specified accuracy between a UE and one or more UEs may be calculated. In some embodiments, the specified accuracy may be indicated by the ranging/sidelink positioning QoS information.

In the cases of the unspecified accuracy, the LMF network element may calculate, based on a default accuracy or an actual measurement condition, a relative distance and/or a relative direction between a UE and one or more UEs.

According to the LMF network element selection method of the embodiments of the present disclosure, the AMF network element determines, based on the ranging/sidelink positioning request as received, the ranging/sidelink positioning capability information required for performing the ranging/sidelink positioning service, and selects, based on the ranging/sidelink positioning capability information and the ranging/sidelink positioning related information included in the ranging/sidelink positioning request, the LMF network element configured to perform the ranging/sidelink positioning service. As a result, the AMF network element is enabled to select a suitable LMF network element for performing the ranging/sidelink positioning service.

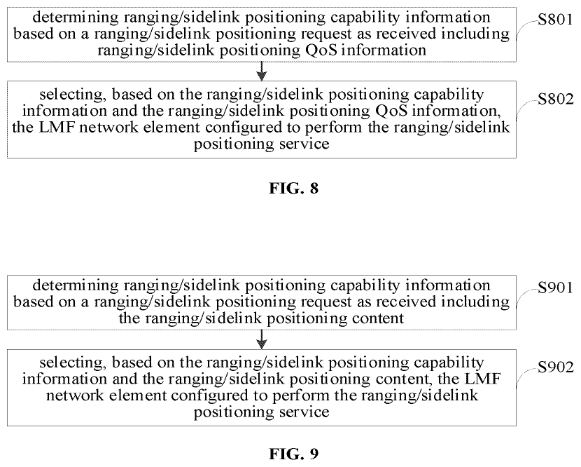

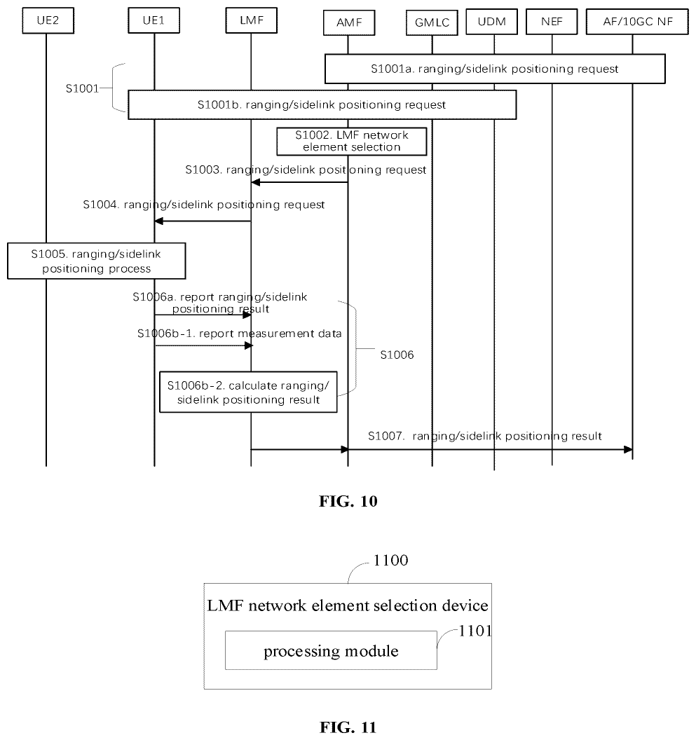

FIG. 8 illustrates a schematic flow diagram of an LMF network element selection method according to an embodiment of the present disclosure. As shown in FIG. 8, the method may be performed by an AMF network element, and may include the following steps S801 to S802.

At S801, ranging/sidelink positioning capability information is determined based on a ranging/sidelink positioning request as received including ranging/sidelink positioning QoS information, where the ranging/sidelink positioning capability information indicates ranging/sidelink positioning capability required by an LMF network element configured to perform a ranging/sidelink positioning service.

At S802, the LMF network element configured to perform the ranging/sidelink positioning service is selected based on the ranging/sidelink positioning capability information and the ranging/sidelink positioning QoS information.

If the ranging/sidelink positioning request received by the AMF network element includes the ranging/sidelink positioning QoS information, the AMF network element, when performing the LMF network element selection, may determine the ranging/sidelink positioning capability information indicative of the ranging/sidelink positioning capability required by the LMF network element configured to perform the ranging/sidelink positioning service, and select the LMF network element based on the ranging/sidelink positioning capability information and the ranging/sidelink positioning QoS information. As a result, an LMF network element having suitable ranging/sidelink positioning capability and satisfying the requirement indicated by the ranging/sidelink positioning QoS information can be selected to perform the ranging/sidelink positioning service.

In some embodiments, the ranging/sidelink positioning QoS information includes a QoS level, a specified accuracy related to the desired ranging/sidelink positioning result, and a response time for performing the ranging/sidelink positioning service.

In some embodiments, the QoS level includes a best effort level, a multi-QoS level, and a guaranteed level.

The best effort level defines the least stringent requirement for the QoS. For example, if a position estimate as obtained does not satisfy the QoS requirement, the position estimate may still be returned but should include indication information indicating that the requested QoS is not satisfied; if a position estimate is not obtained, an error indication should be sent.

The multi-QoS level defines the moderately stringent requirement for the QoS. For example, if a position estimate as obtained does not satisfy the most stringent QoS requirement, an additional position estimate may be triggered at the LMF network element to attempt to satisfy another QoS requirement that is less stringent, and the process may be iterated until the least stringent another QoS requirement has been attempted, and if the position estimate as obtained does not satisfy that least stringent another QoS requirement, the position estimation should be abandoned, and an error indication is sent.

The guaranteed level defines the most stringent requirement for the QoS. For example, if the position estimate as obtained does not satisfy the QoS requirement, the position estimation should be abandoned, and an error indication is sent.

In some embodiments, when the desired ranging/sidelink positioning result is a distance, the specified accuracy related to the desired ranging/sidelink positioning result may indicate the specified accuracy relative to the distance. When the desired ranging/sidelink positioning result is a direction, the specified accuracy related to the desired ranging/sidelink positioning result may indicate the specified accuracy relative to the direction.

The response time for performing the ranging/sidelink positioning service may indicate that the response time is a specified length of time.

In some embodiments, the ranging/sidelink positioning capability includes triggering capability that is used for triggering a ranging/sidelink positioning service between two or more UEs, and reporting capability that is used for reporting a ranging/sidelink positioning result to the AMF network element.

In some embodiments, the ranging/sidelink positioning capability further Includes calculating capability used for calculating the ranging/sidelink positioning result.

In some embodiments, the calculating capability includes any one of the following: calculation of a relative distance between two UEs; calculation of a relative direction between two UEs; calculation of a relative distance with a specified accuracy between two UEs; calculation of a relative direction with a specified accuracy between two UEs; calculation of a relative distance between a UE and a plurality of UEs; calculation of a relative direction between a UE and a plurality of UEs; calculation of a relative distance with a specified accuracy between a UE and a plurality of UEs; and calculation of a relative direction with a specified accuracy between a UE and a plurality of UEs.

If the AMF network element receives a ranging/sidelink positioning request including the ranging/sidelink positioning QoS information, the AMF network element determines, in response to the ranging/sidelink positioning request as received, the ranging/sidelink positioning capability information indicative of the triggering capability, the reporting capability and the calculating capability, and the ranging/sidelink positioning QoS information indicates that the response time for performing the ranging/sidelink positioning service is a low latency, then the AMF network element may select, based on the ranging/sidelink positioning capability information and the ranging/sidelink positioning QoS information, an LMF network element having the triggering capability, the reporting capability and the calculating capability, and satisfying the low latency.

According to the LMF network element selection method of the embodiments of the present disclosure, the AMF network element determines, based on the ranging/sidelink positioning request as received, the ranging/sidelink positioning capability information required for performing the ranging/sidelink positioning service, and selects, based on the ranging/sidelink positioning capability information and the ranging/sidelink positioning QoS information included in the ranging/sidelink positioning request, the LMF network element configured to perform the ranging/sidelink positioning service. As a result, the AMF network element is enabled to select a suitable LMF network element for performing the ranging/sidelink positioning service.

FIG. 9 illustrates a schematic flow diagram of an LMF network element selection method according to an embodiment of the present disclosure. As shown in FIG. 9. the method may be performed by an AMF network element, and may include the following steps S901 to S902.

At S901, ranging/sidelink positioning capability information is determined based on a ranging/sidelink positioning request as received including the ranging/sidelink positioning content, where the ranging/sidelink positioning capability information indicates ranging/sidelink positioning capability required by an LMF network element configured to perform a ranging/sidelink positioning service.

At S902, the LMF network element configured to perform the ranging/sidelink positioning service is selected based on the ranging/sidelink positioning capability information and the ranging/sidelink positioning content.

If the ranging/sidelink positioning request received by the AMF network element includes the ranging/sidelink positioning content, the AMF network element, when performing the LMF network element selection, may determine the ranging/sidelink positioning capability information indicative of the ranging/sidelink positioning capability required by the LMF network element configured to perform the ranging/sidelink positioning service, and select the LMF network element based on the ranging/sidelink positioning capability information and the ranging/sidelink positioning content. As a result, an LMF network element having suitable ranging/sidelink positioning capability and capable of providing the ranging/sidelink positioning result indicated by the ranging/sidelink positioning content can be selected to perform the ranging/sidelink positioning service.

In some embodiments, the ranging/sidelink positioning content is used for indicating a desired ranging/sidelink positioning result, for example, the ranging/sidelink positioning content indicates that the desired ranging/sidelink positioning result is a distance and/or a direction. When the desired ranging/sidelink positioning result is a distance, the LMF network element selected by the AMF network element should be capable of obtaining the distance as the ranging/sidelink positioning result. When the desired ranging/sidelink positioning result is a direction, the LMF network element selected by the AMF network element should be capable of obtaining the direction as the ranging/sidelink positioning result.

In some embodiments, the ranging/sidelink positioning capability includes triggering capability that is used for triggering a ranging/sidelink positioning service between two or more UEs, and reporting capability that is used for reporting a ranging/sidelink positioning result to the AMF network element.

In some embodiments, the ranging/sidelink positioning capability further includes calculating capability used for calculating the ranging/sidelink positioning result.

In some embodiments, the calculating capability includes any one of the following: calculation of a relative distance between two UEs; calculation of a relative direction between two UEs; calculation of a relative distance with a specified accuracy between two UEs; calculation of a relative direction with a specified accuracy between two UEs; calculation of a relative distance between a UE and a plurality of UEs; calculation of a relative direction between a UE and a plurality of UEs; calculation of a relative distance with a specified accuracy between a UE and a plurality of UEs; and calculation of a relative direction with a specified accuracy between a UE and a plurality of UEs.

If the AMF network element receives a ranging/sidelink positioning request that includes the ranging/sidelink positioning content, the AMF network element determines, in response to the ranging/sidelink positioning request, the ranging/sidelink positioning capability information indicative of the triggering capability and the reporting capability, and the ranging/sidelink positioning content indicates that the desired ranging/sidelink positioning result is a distance, then the AMF network element may select, based on the ranging/sidelink positioning capability information and the ranging/sidelink positioning content, an LMF network element having the triggering capability and the reporting capability and capable of obtaining the distance as the ranging/sidelink positioning result.

According to the LMF network element selection method of the embodiments of the present disclosure, the AMF network element determines, based on the ranging/sidelink positioning request as received, the ranging/sidelink positioning capability information required for performing the ranging/sidelink positioning service, and selects, based on the ranging/sidelink positioning capability information and the ranging/sidelink positioning content included in the ranging/sidelink positioning request, the LMF network element configured to perform the ranging/sidelink positioning service. As a result, the AMF network element is enabled to select a suitable LMF network element for performing the ranging/sidelink positioning service.

FIG. 10 illustrates a schematic flow diagram of a ranging/sidelink positioning service according to an embodiment of the present disclosure. As shown in FIG. 10, the process of the service may include the following steps S1001 to S1007.

At S1001, a ranging/sidelink positioning request is generated. This step may include any one of steps S1001a and S1001b. At S1001a, a ranging/sidelink positioning service is initiated by an application function (AF) network element or a 5G core network NF (5GC NF) network element. When the ranging/sidelink positioning service is initiated by the AF network element, the AF network element sends the ranging/sidelink positioning request to a gateway mobile location center (GMLC) network element through a network exposure function (NEF) network element, and the GMLC network element obtains, from a unified data management (UDM) network element, privacy setting and the address of an available AMF network element, and after the available AMF network element is determined, the GMLC network element sends the ranging/sidelink positioning request to the AMF network element. When the ranging/sidelink positioning service is initiated by the 5GC NF network element, the 5GC NF network element sends the ranging/sidelink positioning request to the GMLC network element, the GMLC network element obtains, from the UDM network element, the privacy setting and the address of the available AMF network element, and after the available AMF network element is determined, the GMLC network element sends the ranging/sidelink positioning request to the AMF network element. At S1001b, the ranging/sidelink positioning service is initiated by the UE1. Specifically, the UE1 sends the ranging/sidelink positioning request to the AMF network element, and the AMF network element obtains the privacy setting from the UDM network element.

At S1002, the AMF network element performs IMF network element selection in response to the ranging/sidelink positioning request as obtained.

At S1003, the AMF network element sends the ranging/sidelink positioning request to the selected LMF network element.

At S1004, the selected LMF network element sends the ranging/sidelink positioning request to the UE1 to initiate the ranging/sidelink positioning service.

At S1005, the UE1 and the UE2 perform the ranging/sidelink positioning process.

At S1006, the LMP network element obtains the ranging/sidelink positioning result. This step may include S1006a, or include S1006b-1 and S1006b-2. At S1006a, the UE1 directly reports the ranging/sidelink positioning result to the LMF network element. At S1006b-1, the UE1 reports the measurement data to the LMF network element, and at S1006b-2, the LMF network element calculates the ranging/sidelink positioning result based on the measurement data.

At S1007, the LMF network element sends the ranging/sidelink positioning result to the AMF network element, and the AMF network element sends the ranging/sidelink positioning result to the corresponding network element through interaction with the GMLC network element, the UDM network element, the NEF network element, and the AF/5GC NF network element.

In the above embodiments provided in the present application, the method provided in the embodiments of the present application is described from the perspective of the network device. In order to realize the functions in the method provided in the above embodiments of the present application, the network device may include a hardware structure and/or a software module, and realize the above functions in the form of a hardware structure, a software module, or a hardware structure plus a software module. A certain function of the above-described functions may be performed in the form of a hardware structure, a software module, or a hardware structure plus a software module.

Corresponding to the LMF network element selection method provided in the several embodiments described above, the present disclosure also provides an LMF network element selection device. Since the LMF network element selection device provided in the embodiments of the present disclosure corresponds to the LMF network element selection method provided in the several embodiments described above, the implementation manner of the LMF network element selection method is also applicable to the LMF network element selection device provided in this embodiment, which will not be described in detail in this embodiment.

FIG. 11 is a schematic structural diagram of an LMF network element selection device 1100 provided by an embodiment of the present disclosure. The LMF network element selection device 1100 may be used for an AMF network element.

As shown in FIG. 11, the device 1100 may include a processing module 1101.

The processing module 1101 is configured to select, based on a ranging/sidelink positioning request as received, an LMF network element configured to perform a ranging/sidelink positioning service.

According to the LMF network element selection device in the embodiments of the present disclosure, the AMF network element selects, based on the ranging/sidelink positioning request as received, the LMF network element configured to perform the ranging/sidelink positioning service. As a result, the AMF network element is enabled to select a suitable LMF network element for performing the ranging/sidelink positioning service.

In some embodiments, the processing module 1101 is configured to: determine ranging/sidelink positioning capability information based on the ranging/sidelink positioning request, where the ranging/sidelink positioning capability information indicates ranging/sidelink positioning capability required by the LMF network element configured to perform the ranging/sidelink positioning service; and select, based on the ranging/sidelink positioning capability information, the LMF network element configured to perform the ranging/sidelink positioning service.

In some embodiments, the ranging/sidelink positioning request includes ranging/sidelink positioning related information, and the processing module 1101 is configured to: determine ranging/sidelink positioning capability information based on the ranging/sidelink positioning request, where the ranging/sidelink positioning capability information indicates ranging/sidelink positioning capability required by the LMF network element configured to perform the ranging/sidelink positioning service; and select the LMF network element based on the ranging/sidelink positioning capability information and the ranging/sidelink positioning related information. The ranging/sidelink positioning related information includes at least one of the following: ranging/sidelink positioning content that is used for indicating a desired ranging/sidelink positioning result; and ranging/sidelink positioning QoS information.

In some embodiments, the ranging/sidelink positioning capability includes: triggering capability that is used for triggering a ranging/sidelink positioning service between two or more UEs; and reporting capability that is used for reporting a ranging/sidelink positioning result to the AMF network element.

In some embodiments, the ranging/sidelink positioning capability further includes calculating capability used for calculating the ranging/sidelink positioning result.

In some embodiments, the calculating capability includes any one of the following: calculation of a relative distance between two UEs; calculation of a relative direction between two UEs; calculation of a relative distance with a specified accuracy between two UEs; calculation of a relative direction with a specified accuracy between two UEs; calculation of a relative distance between a UE and a plurality of UEs; calculation of a relative direction between a UE and a plurality of UEs; calculation of a relative distance with a specified accuracy between a UE and a plurality of UEs; and calculation of a relative direction with a specified accuracy between a UE and a plurality of UEs.

In some embodiments, the ranging/sidelink positioning QoS information includes a QoS level, a specified accuracy related to the desired ranging/sidelink positioning result, and a response time for performing the ranging/sidelink positioning service.

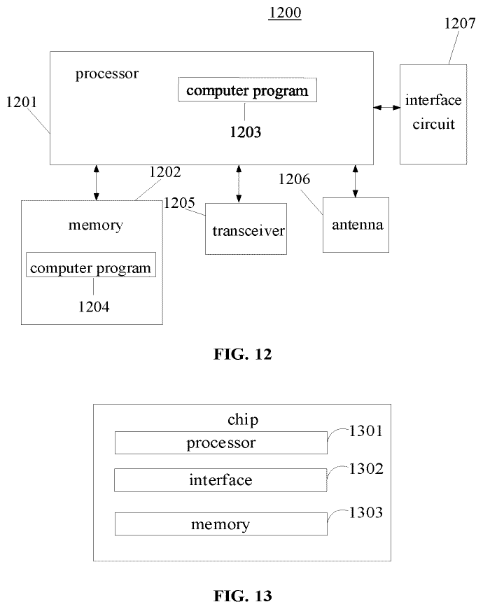

Referring to FIG. 12, FIG. 12 is a schematic structural diagram of a communication device 1200 provided by an embodiment of the present application. The communication device 1200 may be a network device or a UE, may be a chip, a chip system or a processor, etc., that supports a network device to implement the method described above, or may be a chip, a chip system or a processor, etc., that supports a UE to implement the method described above. The device may be configured to implement the method described in the aforementioned method embodiments. For details, please refer to the illustration in the above method embodiments.

The communication device 1200 may include one or more processors 1201. The processor 1201 may be a general purpose processor or specialized processor, etc. For example, the processor 1201 may be a baseband processor or a central processor. The baseband processor may be configured to process communication protocols and communication data. The central processor may be configured to control the communication device (e.g., a base station, a baseband chip, a terminal device, a terminal device chip, a DU, or a CU), execute a computer program, and process data of the computer program.

Optionally, the communication device 1200 may further include one or more memories 1202. The memory 1202 may store a computer program 1204. The processor 1201 executes the computer program 1204 to cause the communication device 1200 to perform the method described in the above method embodiments. Optionally, the memory 1202 may also store data. The communication device 1200 and the memory 1202 may be provided separately or may be integrated together.

Optionally, the communication device 1200 may further include a transceiver 1205 and an antenna 1206. The transceiver 1205 may be referred to as a transceiver unit, a transceiver device, or a transceiver circuit, etc., and is configured to implement the receiving and sending functions. The transceiver 1205 may include a receiver and a sender. The receiver may be referred to as a receiving device or a receiving circuit, etc., and is configured to implement a receiving function. The sender may be referred to as a sending device or a sending circuit, etc., and is configured to implement a sending function.

Optionally, the communication device 1200 may further include one or more interface circuits 1207. The interface circuit 1207 is configured to receive a code instruction and transmit the code instruction to the processor 1201. The processor 1201 runs the code instruction to cause the communication device 1200 to perform the method described in the above method embodiments.

In an implementation, the processor 1201 may include a transceiver configured to implement the receiving and sending functions. For example, the transceiver may be a transceiver circuit, an interface, or an interface circuit. The transceiver circuit, interface, or interface circuit configured to implement the receiving and sending functions may be separated or may be integrated together. The transceiver circuit, interface, or interface circuit described above may be configured for code/data reading and writing, or the transceiver circuit, interface, or interface circuit described above may be configured for signal transmission or delivery.

In an implementation, the processor 1201 may store a computer program 1203. The computer program 1203 is run on the processor 1201 and may cause the communication device 1200 to perform the method described in the above method embodiments. The computer program 1203 may be solidified in the processor 1201, in which case the processor 1201 may be implemented by hardware.

In an implementation, the communication device 1200 may include a circuit. The circuit may implement the functions of sending, receiving or communicating in the aforementioned method embodiments. The processor and transceiver described in the present application may be implemented in an integrated circuit (IC), an analog IC, a radio frequency integrated circuit (RFIC), a mixed signal IC, an application specific integrated circuit (ASIC), a printed circuit board (PCB), and an electronic device, etc. The processor and transceiver may also be manufactured by using various IC process technologies, such as complementary metal oxide semiconductor (CMOS), nMetal-oxide-semiconductor (NMOS), positive channel metal oxide semiconductor (PMOS), bipolar junction transistor (BJT), bipolar CMOS (BiCMOS), silicon germanium (SiGe), gallium arsenide (GaAs), etc.

The communication device in the description of the above embodiments may be a network device or a UE, but the scope of the communication device described in the present application is not limited thereto. The structure of the communication device may not be limited by FIG. 12. The communication device may be an independent device or may be part of a large apparatus. For example, the communication device may be:
(1) an independent integrated circuit (IC), a chip, or a chip system or subsystem;
(2) a set that has one or more ICs, optionally, the IC set may also include a storage component configured to store data and computer programs;
(3) an ASIC, such as a modem;
(4) a module that is capable of being embedded in other devices;
(5) a receiving device, a terminal device, an intelligent terminal device, a cellular phone, a wireless device, a handheld device, a mobile unit, a vehicle-mounted device, a network device, a cloud device, or an artificial intelligence device, etc.;
(6) others and so on.

For the cases where the communication device may be a chip or a chip system, please refer to the schematic structural diagram of the chip shown in FIG. 13. The chip shown in FIG. 13 includes a processor 1301 and an interface 1302. In some embodiments, the number of the processor 1301 may be one or more, and the number of interfaces 1302 may be more than one.

Optionally, the chip further includes a memory 1303, where the memory 1303 is configured to store necessary computer programs and data.

Those skilled in the art can also understand that various illustrative logical blocks and steps listed in the embodiments of the present application may be implemented through electronic hardware, computer software, or a combination of the two. Whether such functions are implemented through hardware or software depends on the specific application and design requirements of the overall system. Those skilled in the art can use various methods to implement the described functions for each specific application, but such implementations should not be understood as exceeding the scope of protection of the embodiments of the present application.

The present application also provides a readable storage medium. The readable storage medium stores an instruction. The instruction, when executed by a computer, implements the function of any of the method embodiments described above.

The present application also provides a computer program product. The computer program product, when executed by a computer, implements the function of any of the method embodiments described above.

The above embodiments may be implemented in whole or in part by software, hardware, firmware, or any combination thereof. When implemented by using software, the above embodiments may be implemented in whole or in part in the form of a computer program product. The computer program product includes one or more computer programs. When the computer program is loaded and executed on a computer, a process or function is produced in whole or in part in accordance with the embodiments of the present application. The computer may be a general purpose computer, a specialized computer, a computer network, or other programmable devices. The computer program may be stored in a computer-readable storage medium or transmitted from one computer-readable storage medium to another computer-readable storage medium, e.g., the computer program may be transmitted from a web site, computer, server, or data center via a wired (e.g., coaxial cable, fiber optic, digital subscriber line (DSL)) or wireless (e.g., infrared, wireless, microwave, etc.) manner to another website site, computer, server, or data center. The computer-readable storage medium may be any usable medium to which a computer has access, or a data storage device such as a server or a data center including one or more usable media integration. The usable medium may be a magnetic medium (e.g., a floppy disk, a hard disk, a tape), an optical medium (e.g., a high-density digital video disc (DVD)), or a semiconductor medium (e.g., a solid state disk (SSD)), etc.

Those ordinary skilled in the art can understand that various numerical numbers such as “first” and “second” involved in the present application are only differentiation for the convenience of the description, and are not used for limiting the scope of the embodiments of the present application or indicate the sequential order.

The “at least one” in the present application may also be described as one or more, and the “plurality” may be two, three, four, or more, without limitations in the present application. In the embodiments of the present application, for one type of technical feature, technical features of this type are distinguished by “first”, “second”, “third”, “A”, “B”, “C”, and “D”, etc. The technical features described by “first”, “second”, “third”, “A”, “B”, “C”, and “D”, etc. are in no order of sequence or size.

As used in this article, the terms “machine-readable medium” and “computer-readable medium” refer to any computer program product, device, and/or apparatus (e.g., disk, optical disk, memory, programmable logic device (PLD)) configured to provide machine instructions and/or data to a programmable processor, including machine-readable media that receive machine instructions as machine-readable signals. The term “machine-readable signal” refers to any signal used for providing machine instructions and/or data to the programmable processor.

The system and technique described herein may be implemented in a computing system that includes a back-end component (e.g., as a data server), a computing system that includes a middleware component (e.g., an application server), a computing system that includes a front-end component (e.g., a user computer that has a graphical user interface or a web browser through which a user can interact with the implementations of the system and technique described herein), or a computing system that includes any combination of such a back-end component, a middleware component, or a front-end component. The components of the system may be interconnected by digital data communications (e.g., a communication network) in any form or medium. Examples of the communication network include a local area network (LAN), a wide area network (WAN), and the Internet.

The computer system may include a client and a server. The client and the server are generally remote from each other and typically interact through the communication network. The relationship between the client and the server is generated by running computer programs on corresponding computers that have a client-server relationship with each other.

It should be understood that steps may be reordered, added, or deleted by using various forms of the processes shown above. For example, the steps documented in the present disclosure may be performed in parallel or performed sequentially, or may be performed in a different order, as long as the result desired by the technical solution disclosed in the present disclosure can be achieved, which are not limited herein.

Furthermore, it should be understood that various embodiments described in the present application may be implemented individually or in combination with other embodiments as permitted by the scheme.

Those ordinary skilled in the art can realize that the units and algorithm steps of the examples described in combination with the disclosed embodiments in this article may be implemented in electronic hardware, or a combination of computer software and electronic hardware. Whether these functions are executed in hardware or software manners depends on the specific application and design constraints of the technical solution. Professional technicians may use different methods to implement the described functions for each specific application, but such implementations should not be considered beyond the scope of the present application.

Those skilled in the art can clearly understand that for the convenience and conciseness of the description, the specific working processes of the systems, devices and units described above may refer to the corresponding processes in the aforementioned method embodiments, which will not be repeated here.

The above is only the detailed description of the present application, but the scope of protection of the present application is not limited to this. Any technician familiar with this technical field can easily think of changes or replacements within the technical scope disclosed in the present application, and these changes or replacements should be covered within the scope of protection of the present application. Therefore, the scope of protection of the present application shall be subject to the scope of protection of the claims.

1. A location management function (LMF) network element selection method, performed by an access and mobility management function (AMF) network element, the method comprising:
selecting, based on a ranging/sidelink positioning request as received, an LMF network element configured to perform a ranging/sidelink positioning service.

2. The method according to claim 1, wherein selecting the LMF network element comprises:
determining ranging/sidelink positioning capability information based on the ranging/sidelink positioning request, wherein the ranging/sidelink positioning capability information indicates ranging/sidelink positioning capability required by the LMF network element; and
selecting, based on the ranging/sidelink positioning capability information, the LMF network element configured to perform the ranging/sidelink positioning service.

3. The method according to claim 1, wherein the ranging/sidelink positioning request comprises ranging/sidelink positioning related information, and selecting the LMF network element comprises:
determining ranging/sidelink positioning capability information based on the ranging/sidelink positioning request, wherein the ranging/sidelink positioning capability information indicates ranging/sidelink positioning capability required by the LMF network element; and
selecting the IMF network element based on the ranging/sidelink positioning capability information and the ranging/sidelink positioning related information, wherein
the ranging/sidelink positioning related information comprises at least one of:
ranging/sidelink positioning content, used for indicating a desired ranging/sidelink positioning result; or
ranging/sidelink positioning quality of service (QoS) information.

4. The method according to claim 2, wherein the ranging/sidelink positioning capability comprises:
triggering capability, used for triggering a ranging/sidelink positioning service between two or more user equipment (UEs); and
reporting capability, used for reporting a ranging/sidelink positioning result to the AMF network element.

5. The method according to claim 4, wherein the ranging/sidelink positioning capability further comprises calculating capability used for calculating the ranging/sidelink positioning result.

6. The method according to claim 5, wherein the calculating capability comprises any one of:
calculation of a relative distance between two UEs;
calculation of a relative direction between two UEs;
calculation of a relative distance with a specified accuracy between two UEs;
calculation of a relative direction with a specified accuracy between two UEs;
calculation of a relative distance between a UE and a plurality of UEs;
calculation of a relative direction between a UE and a plurality of UEs;
calculation of a relative distance with a specified accuracy between a UE and a plurality of UEs; or
calculation of a relative direction with a specified accuracy between a UE and a plurality of UEs.

7. The method according to claim 3, wherein the ranging/sidelink positioning QoS information comprises a QoS level, a specified accuracy related to the desired ranging/sidelink positioning result, and a response time for performing the ranging/sidelink positioning service.

8-14. (canceled)

15. A communication device, comprising:
a transceiver;
a memory; and
a processor, connected to the transceiver and the memory respectively, wherein the processor, through executing a computer-executable instruction of the memory, is configured to control receiving and sending of a wireless signal of the transceiver, and is configured to:
select, based on a ranging/sidelink positioning request as received an IMF network element configured to perform a ranging/sidelink positioning service.

16. A non-transitory computer-readable storage medium storing instructions that, when executed by one or more processors of a device, cause the device to:
select, based on a ranging/sidelink positioning request as received, an LMF network element configured to perform a ranging/sidelink positioning service.

17. The communication device according to claim 15, wherein the processor is further configured to:
determine ranging/sidelink positioning capability information based on the ranging/sidelink positioning request, wherein the ranging/sidelink positioning capability information indicates ranging/sidelink positioning capability required by the LMF network element; and
select, based on the ranging/sidelink positioning capability information, the LMF network element configured to perform the ranging/sidelink positioning service.

18. The communication device according to claim 15, wherein the ranging/sidelink positioning request comprises ranging/sidelink positioning related information, and the processor is further configured to:
determine ranging/sidelink positioning capability information based on the ranging/sidelink positioning request, wherein the ranging/sidelink positioning capability information indicates ranging/sidelink positioning capability required by the LMF network element; and
select the LMF network element based on the ranging/sidelink positioning capability information and the ranging/sidelink positioning related information, wherein
the ranging/sidelink positioning related information comprises at least one of:
ranging/sidelink positioning content, used for indicating a desired ranging/sidelink positioning result; or
ranging/sidelink positioning quality of service (QoS) information.

19. The communication device according to claim 17, wherein the ranging/sidelink positioning capability comprises:
triggering capability, used for triggering a ranging/sidelink positioning service between two or more user equipment (UEs); and
reporting capability, used for reporting a ranging/sidelink positioning result to an AMF network element.

20. The communication device according to claim 19, wherein the ranging/sidelink positioning capability further comprises calculating capability used for calculating the ranging/sidelink positioning result.

21. The communication device according to claim 20, wherein the calculating capability comprises any one of:
calculation of a relative distance between two UEs;
calculation of a relative direction between two UEs;
calculation of a relative distance with a specified accuracy between two UEs;
calculation of a relative direction with a specified accuracy between two UEs;
calculation of a relative distance between a UE and a plurality of UEs;
calculation of a relative direction between a UE and a plurality of UEs;
calculation of a relative distance with a specified accuracy between a UE and a plurality of UEs; or
calculation of a relative direction with a specified accuracy between a UE and a plurality of UEs.

22. The communication device according to claim 18, wherein the ranging/sidelink positioning QoS information comprises a QoS level, a specified accuracy related to the desired ranging/sidelink positioning result, and a response time for performing the ranging/sidelink positioning service.

23. The non-transitory computer-readable storage medium according to claim 16, wherein selecting the LMF network element comprises:
determining ranging/sidelink positioning capability information based on the ranging/sidelink positioning request, wherein the ranging/sidelink positioning capability information indicates ranging/sidelink positioning capability required by the LMF network element; and
selecting, based on the ranging/sidelink positioning capability information, the LMF network element configured to perform the ranging/sidelink positioning service.

24. The non-transitory computer-readable storage medium according to claim 16, wherein the ranging/sidelink positioning request comprises ranging/sidelink positioning related information, and selecting the LMF network element comprises:
determining ranging/sidelink positioning capability information based on the ranging/sidelink positioning request, wherein the ranging/sidelink positioning capability information indicates ranging/sidelink positioning capability required by the LMF network element; and
selecting the IMF network element based on the ranging/sidelink positioning capability information and the ranging/sidelink positioning related information, wherein
the ranging/sidelink positioning related information comprises at least one of:
ranging/sidelink positioning content, used for indicating a desired ranging/sidelink positioning result; or
ranging/sidelink positioning quality of service (QoS) information.

25. The non-transitory computer-readable storage medium according to claim 23, wherein the ranging/sidelink positioning capability comprises;
triggering capability, used for triggering a ranging/sidelink positioning service between two or more user equipment (UEs); and
reporting capability, used for reporting a ranging/sidelink positioning result to an AMF network element.

26. The non-transitory computer-readable storage medium according to claim 25, wherein the ranging/sidelink positioning capability further comprises calculating capability used for calculating the ranging/sidelink positioning result.

27. The non-transitory computer-readable storage medium according to claim 26, wherein the calculating capability comprises any one of:
calculation of a relative distance between two UEs;
calculation of a relative direction between two UEs;
calculation of a relative distance with a specified accuracy between two UEs;
calculation of a relative direction with a specified accuracy between two UEs;
calculation of a relative distance between a UE and a plurality of UEs;
calculation of a relative direction between a UE and a plurality of UEs;
calculation of a relative distance with a specified accuracy between a UE and a plurality of UEs; or
calculation of a relative direction with a specified accuracy between a UE and a plurality of UEs.
